(19) United States
(12) Patent Application Publication
(10) Pub. No.: US 2021/0063152 A1
(43) Pub. Date: Mar. 4, 2021

(54) MAPPING METHODS, MOVABLE PLATFORMS, AND COMPUTER-READABLE STORAGE MEDIA

(71) Applicant: SZ DJI TECHNOLOGY CO., LTD., Shenzhen (CN)

(72) Inventors: Bo WU, Shenzhen (CN); Litian ZHANG, Shenzhen (CN); Jie QIAN, Shenzhen (CN)

(73) Assignee: SZ DJI TECHNOLOGY CO., LTD., Shenzhen (CN)

(21) Appl. No.: 17/094,781

(22) Filed: Nov. 10, 2020

Related U.S. Application Data
(63) Continuation of application No. PCT/CN2018/096324, filed on Jul. 19, 2018.

(51) Int. Cl. G01C 11/02; B64C 39/02

(52) U.S. Cl. CPC G01C 11/025; B64C 39/024; G01S 17/894; B64C 2201/123; B64C 2201/146; B64C 2201/027

(57) ABSTRACT

A mapping method, a movable platform, and a computer-readable storage medium are provided. The mapping method includes: determining a designated area of a local map based on planning information of the movable platform, wherein the designated area of the local map does not overlap with a location of the movable platform in the local map; and generating a local map based on at least a part of map information obtained by the movable platform and the designated area of the local map. The problem of low map utilization is resolved, the map utilization and user experience are improved, and an effective range of the local map is expanded.

### RELATED APPLICATIONS

The present patent document is a continuation of PCT Application Serial No. PCT/CN2018/096324, filed on Jul. 19, 2018, designating the United States and published in Chinese, which is hereby incorporated by reference.

### TECHNICAL FIELD

The present disclosure relates to the field of image processing technologies, and in particular, to a mapping method, a movable platform, and a computer-readable storage medium.

### BACKGROUND

Unmanned vehicles such as unmanned aerial vehicles (UAV) have been developed for applications in various fields, including consumer applications and industrial applications. For example, unmanned aerial vehicles may be manipulated for entertainment, photographing/shooting, monitoring, delivery, or other applications. Unmanned aerial vehicles have expanded every aspect of personal life.

As use of unmanned aerial vehicles is increasingly prevalent, the unmanned aerial vehicles have more functions. Mapping is a typical application of an unmanned aerial vehicle. A purpose of mapping includes: outputting a map of surrounding obstacles (or terrains) for navigation of the unmanned aerial vehicle, so that the unmanned aerial vehicle plans the path according to the map, avoids the obstacles, and arrives at a destination.

However, the current mapping methods have relatively low map utilization and poor user experience.

### SUMMARY

The present disclosure provides a map construction method, a movable platform, and a computer-readable storage medium, which may resolve the problem of low map utilization, and then to improve the map utilization and user experience.

In accordance with a first aspect of the present disclosure, there is provided a map construction method for a movable platform. The method comprises: determining a designated area of a local map based on planning information of the movable platform, wherein the designated area of the local map is outside a location of the movable platform in the local map; and generating the local map based on at least a part of map information obtained by the movable platform and the designated area of the local map.

In accordance with a second aspect of the present disclosure, there is provided a movable platform, which comprises at least one storage medium including a set of instructions for generating a map; and at least one processor in communication with the at least one storage medium. During operation, the at least one processor read and execute the set of instructions to: determine a designated area of a local map based on planning information of the movable platform, wherein the designated area of the local map is outside of a location of the movable platform in the local map; and generate the local map based on at least a part of map information obtained by the movable platform and the designated area of the local map.

In accordance with a third aspect of the present disclosure, there is provided a non-transitory computer-readable storage medium, which comprises a set of instructions for generating a map. When executed by at least one processor, the set of instructions directs the at least one processor to perform acts of: determining a designated area of a local map based on planning information of the movable platform, wherein the designated area of the local map is outside a location of the movable platform in the local map; and generating the local map based on at least a part of map information obtained by the movable platform and the designated area of the local map

As can be learned from the technical solution above, in some embodiments of the present disclosure provides a high efficiency map construction method, which may resolve the problem of low map utilization, then to improve the map utilization and user experience, and expend the effective range of the local map without increasing storage consumption and computational complexity.

### BRIEF DESCRIPTION OF THE DRAWINGS

In order to describe the technical solutions in the embodiments of the present disclosure more clearly, the following briefly describes the accompanying drawings required for describing the embodiments of the present disclosure Apparently, the accompanying drawings in the following description show merely some embodiments described in the present disclosure, and those of ordinary skill in the art may further obtain other accompanying drawings based on these accompanying drawings without inventive effort.

FIG. 1 is a schematic structural diagram of an unmanned aerial vehicle according to some exemplary embodiments of the present disclosure;

FIG. 2 is a schematic flowchart of a mapping method according to some exemplary embodiments of the present disclosure;

FIG. 3 is a schematic flowchart of another mapping method according to some exemplary embodiments of the present disclosure;

FIG. 4 is a top view of a three-dimensional space in a navigation coordinate system on a horizontal plane according to some exemplary embodiments of the present disclosure; and

FIG. 5 is a structural block diagram of a movable platform according to some exemplary embodiments of the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure. In addition, under a condition that no conflict occurs, the following embodiments and features in the embodiments may be mutually combined. The terms used in the present disclosure are used only to describe specific embodiments, and not intended to limit the present disclosure. The terms “a”, “said”, and “the” in singular forms used in the present disclosure and the claims are also intended to include plural forms thereof, unless otherwise clearly indicated in a context. It may be appreciated that the term “and/or” used in this specification includes any or all possible combinations of one or more associated listed items.

Although terms such as first, second, and third may be used to describe various types of information in the present disclosure, the information is not limited to the terms. The terms are used to distinguish information of a same type from each other. For example, without departing from the scope of the present disclosure, first information may also be referred to as second information; and similarly, second information may also be referred to as first information. This depends on a context. In addition, a used term “if” may be interpreted as “when”, or “while”, or “in response to determining that”.

An embodiment of the present disclosure provides a mapping method. The method may be applied to a movable platform. The movable platform may include but is not limited to at least one of a robot, an unmanned aerial vehicle, or an unmanned vehicle.

The mapping method may implement synchronous positioning and mapping (that is, generating map). Specifically, it is expected that the movable platform may depart from an unknown place in an unknown environment, during the movement, through repeated observation of the map information (such as wall corners, pillars, etc.), locate its own position and posture, and then generate a map incrementally according to its own position and posture, so as to achieve the purpose of synchronous positioning and mapping.

For ease of description, take the example of an unmanned aerial vehicle as the movable platform. The unmanned aerial vehicle is equipped with a binocular/monocular camera or a TOF (Time of Flight) camera. The unmanned aerial vehicle may obtain map information by using a plurality of images shot by the binocular camera or a plurality of images shot by the monocular camera in the moving process, or using the TOF camera for photographing, and generate a map based on the map information. When the movable platform is a robot or an unmanned vehicle, a process is similar to that of the unmanned aerial vehicle, and will not be repeated here.

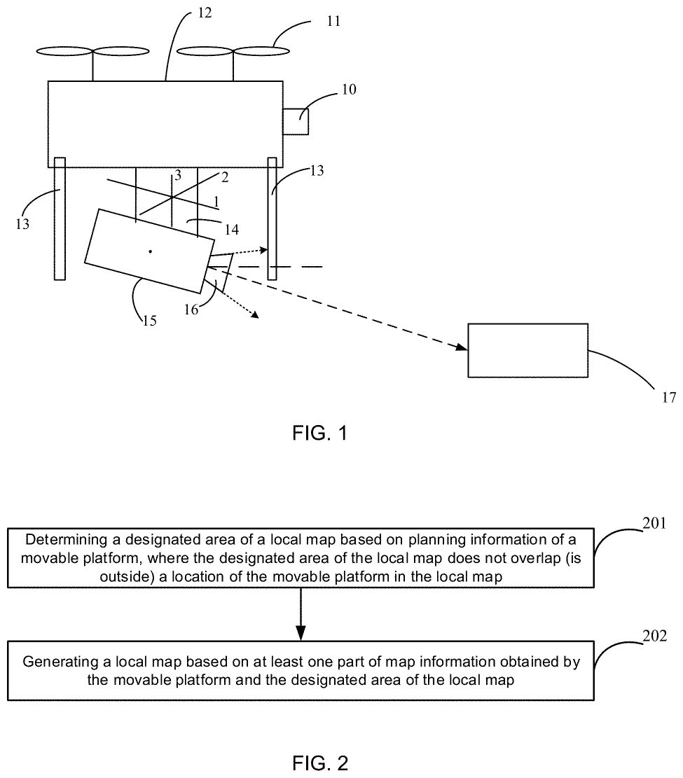

FIG. 1 is a schematic structural diagram of an unmanned aerial vehicle according to some exemplary embodiments of the present disclosure. Reference numeral 10 indicates a nose of the unmanned aerial vehicle, reference numeral 11 indicates a propeller of the unmanned aerial vehicle, reference numeral 12 indicates a body of the unmanned aerial vehicle, reference numeral 13 indicates a tripod of the unmanned aerial vehicle, reference numeral 14 indicates a gimbal on the unmanned aerial vehicle, reference numeral 15 indicates a photographing device mounted on the gimbal 14, the photographing device 15 is connected to the body 12 of the unmanned aerial vehicle via the gimbal 14, reference numeral 16 indicates a shooting lens of the photographing device, and reference numeral 17 indicates a target object.

The gimbal 14 may be a three-axis gimbal, that is, the gimbal 14 may rotate about a roll axis (Roll axis), a pitch axis (Pitch axis), and a yaw axis (Yaw axis) of the gimbal. As shown in FIG. 1, reference numeral 1 indicates the Roll axis of the gimbal, reference numeral 2 indicates the Pitch axis of the gimbal, and reference numeral 3 indicates the Yaw axis of the gimbal. When the gimbal rotates about the Roll axis, a roll angle of the gimbal changes; when the gimbal rotates about the Pitch axis, a pitch angle of the gimbal changes; when the gimbal rotates about the Yaw axis, a yaw angle of the gimbal changes. In addition, when the gimbal 14 rotates about one or more of the Roll axis, the Pitch axis, and the Yaw axis, the photographing device 15 rotates following the rotation of the gimbal 14, so that the photographing device 15 can photograph the target object 17 from different shooting directions and angles.

Similar to the gimbal 14, the body 12 of the unmanned aerial vehicle may also rotate about a Roll axis, a Pitch axis, and a Yaw axis of the body 12. When the body of the unmanned aerial vehicle rotates about the Roll axis, a roll angle of the body changes; when the body of the unmanned aerial vehicle rotates about the Pitch axis, a pitch angle of the body changes; when the body of the unmanned aerial vehicle rotates about the Yaw axis, a yaw angle of the body changes.

The foregoing process briefly describes a structure of the unmanned aerial vehicle. To discover map information around the unmanned aerial vehicle and generate a map based on the map information, the unmanned aerial vehicle may obtain map information via the binocular camera or the TOF camera, for example, discover that the target object 17 is an obstacle surrounding the unmanned aerial vehicle via the binocular camera or the TOF camera.

In an example, a global map or a local map may be generated according to the surrounding of the unmanned aerial. In this embodiment, generating of a local map is taken as an example. The unmanned aerial vehicle may use the local map to implement obstacle avoidance or path planning within a local area, such as using the local map to achieve functions of waypoint control or tracking.

In an example, in order to generate a local map, a local area may be selected. For example, taking the unmanned aerial vehicle as a center, an area of 16 meters*16 meters*16 meters may be selected as a local area, and a local map is generated on the basis of the local area. Based on this, the final generated local map may include a map within a range of 8 meters in front of the unmanned aerial vehicle, a map within a range of 8 meters behind the unmanned aerial vehicle, a map within a range of 8 meters on a left side of the unmanned aerial vehicle, a map within a range of 8 meters on a right side of the unmanned aerial vehicle, a map within a range of 8 meters above the unmanned aerial vehicle, and a map within a range of 8 meters below the unmanned aerial vehicle.

However, the map utilization rate of the foregoing manner is low. For example, if the unmanned aerial vehicle flies straightly at a high speed toward one direction, the map within the range of 8 meters behind the unmanned aerial vehicle will not help the unmanned aerial vehicle avoid obstacles.

In view of the foregoing discovery, in this embodiment, a designated area of a local map may be determined based on planning information of a movable platform, and the designated area of the local map does not overlap with the location of the movable platform in the local map, that is, the designated area of the local map is outside the location of the movable platform in the local map; and the local map is generated based on the map information and the designated area of the local map. In this way, in the process of generating the local map, areas of the local map can be set more reasonable. Without increasing a size of the local map, an effective range of the local map can be expanded, and without increasing memory consumption and computational complexity, the map utilization can be improved, and user experience can be improved. Therefore, a highly effective mapping method is provided.

FIG. 2 is a flowchart of a mapping method according to some exemplary embodiments of the present disclosure. The method may be applied to a movable platform (for example, a robot, an unmanned aerial vehicle, or an unmanned vehicle). The method may include the following steps:

Step 201: determining a designated area of a local map based on planning information of a movable platform, wherein the designated area of the local map does not overlap with the a location of the movable platform in the local map, that is, the designated area of the local map is outside the location of the movable platform in the local map.

In an example, the step of determining a designated area of a local map based on planning information of a movable platform may include but is not limited to: method 1: obtaining an area of interest of the movable platform, and determining the designated area of the local map based on the area of interest, where the area of interest may be input to the movable platform by a user via a control device; method 2: obtaining a moving direction of the movable platform, and determining the designated area of the local map based on the moving direction; method 3: obtaining a moving direction and a moving speed of the movable platform, and determining the designated area of the local map based on the moving direction and the moving speed.

In method 2, the step of determining the designated area of the local map based on the moving direction may include: determining a directional relationship between the designated area of the local map and the movable platform based on the moving direction, and determining the designated area of the local map based on the directional relationship, that is, the designated area of the local map meets the directional relationship with the movable platform.

In method 3, the step of determining the designated area of the local map based on the moving direction and the moving speed may include: determining a directional relationship between the designated area of the local map and the movable platform based on the moving direction; determining a distance relationship between the designated area of the local map and the movable platform based on the moving speed; and determining the designated area of the local map based on the directional relationship and the distance relationship.

In method 2 or method 3, the directional relationship may include the moving direction of the movable platform.

In method 3, the distance relationship is proportional to the moving speed of the movable platform.

Step 202: generating a local map based on at least a part of map information obtained by the movable platform and the designated area of the local map.

The map information may be obtained via a binocular camera or a TOF camera. The map information is not limited as long as a local map can be generated by using the map information. That is to say, the local map is generated based on at least a part of map information obtained by the movable platform with the designated area of the local map as a center, and there is no limitation of the mapping methods.

In an example, the step of generating a local map based on at least a part of map information obtained by the movable platform and the designated area of the local map may include but is not limited to: by taking the designated area of the local map as a center, generating a local map of a predetermined shape and a predetermined size based on the at least a part of map information obtained by the movable platform. For example, the predetermined shape may include but is not limited to a rectangle, a cone, or a sphere. When the predetermined shape is a rectangle, the predetermined size may be 16 meters*16 meters*16 meters, that is, with the designated area of the local map as a center, including a map within a range of 8 meters in front of the designated area, and a map within a range of 8 meters behind the designated area, a map within a range of 8 meters on a left side of the designated area, a map within a range of 8 meters on a right side of the designated area, a map within a range of 8 meters above the designated area, and a map within a range of 8 meters below the designated area.

In an example, after the local map is generated based on the at least a part of map information obtained by the movable platform and the designated area of the local map, the local map may be further used to perform obstacle detection. This method of obstacle detection is not limited.

In the foregoing embodiment, the designated area may include a central area of the local map. For ease of description, the central area of the local map is used as an example for description subsequently.

Based on the foregoing technical solution, in this embodiment of the present disclosure, a designated area of a local map may be determined based on planning information of a movable platform, wherein the designated area of the local map does not overlap with a location of the movable platform in the local map, that is, the designated area of the local map is outside the location of the movable platform in the local map; and a local map is generated based on the map information and the designated area of the local map. In this way, in a process of generating the local map, areas of the local map can be set more reasonably. Without increasing a size of the local map, an effective range of the local map can be expanded, and without increasing memory consumption and computational complexity, the problem of low map utilization can be resolved. Therefore, the map utilization can be improved, and user experience can be improved, and then a highly effective mapping method is provided.

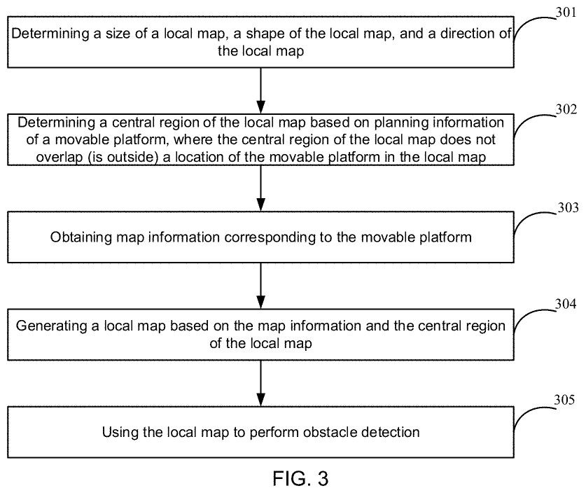

The following describes the foregoing mapping method in detail with reference to a specific application scenario. Refer to FIG. 3, which is a flowchart of a mapping method according to some exemplary embodiments of the present disclosure. The method may include the following steps:

Step 301: determining a size, a shape, and a direction of the local map.

The shape of the local map may include but is not limited to a rectangle, a cone, or a sphere. For ease of description, a rectangle is used as an example for description subsequently, and processing methods of other shapes are similar.

The size of the local map may be configured based on experience. For different application scenarios, different sizes may also be configured for the local map. For example, in an application scenario of high-speed flight, a large size, such as 64 meters*64 meters*64 meters, may be configured for the local map; but in an application scenario of low-speed flight, a small size, such as 16 meters*16 meters*16 meters, may be configured for the local map. The size of the local map is not limited. Subsequently, an example in which the size of the local map is 16 meters*16 meters*16 meters is used for ease of description.

The direction of the local map may be configured based on experience.

For example, the direction of the local map is set to the northeast direction. Certainly, the direction of the local map may also be other directions, and there is no limitation on this matter.

Step 302: determining a central area of the local map based on planning information of the movable platform, wherein the central area of the local map does not overlap with the location of the movable platform in the local map, that is, the central area of the local map is outside the location of the movable platform.

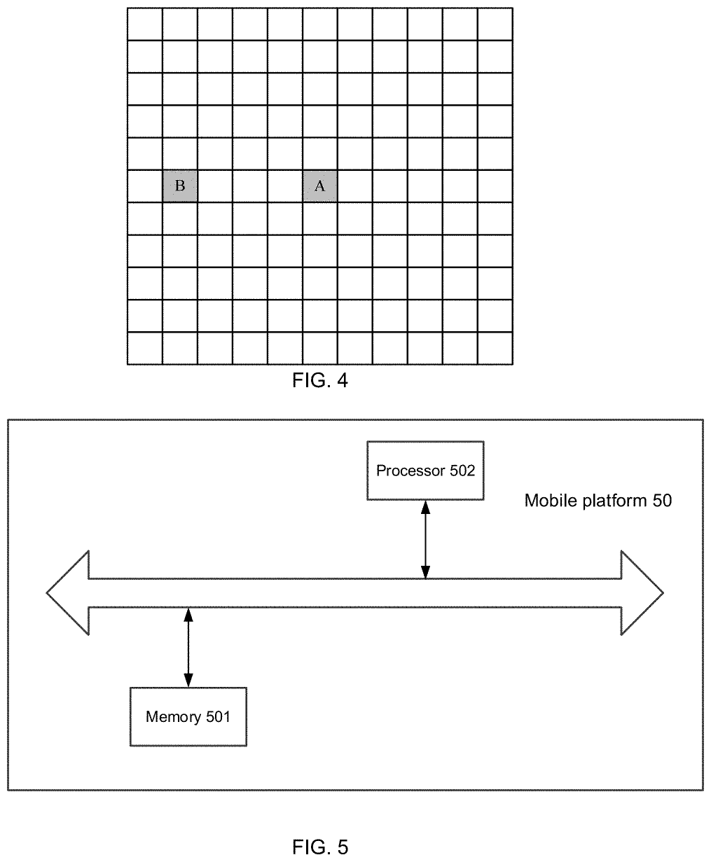

FIG. 4 is a top view of a three-dimensional space in a navigation coordinate system on a certain horizontal plane according to some exemplary embodiments of the present disclosure. The central area of the local map is position A, and the location of the movable platform in the local map is position B. Obviously, the central area of the local map does not overlap with the location of the mobile platform in the local map.

In an example, in order to determine the central area of the local map, the following methods may be adopted. Certainly, the foregoing method 1 to method 3 are only a few examples of the methods to planning information, and there are no limitation on this matter.

Method 1: a user inputs an area of interest to the movable platform via a control device, and the movable platform may obtain the area of interest and determine the central area of the local map based on the area of interest.

The control device may include, but not limited to: a remote control, a smartphone, a mobile phone, a tablet computer, a personal digital assistant (PDA), a laptop computer, a desktop computer, a media content player, a video game station or system, a virtual reality system, an augmented reality system, a wearable apparatus (for example, a watch, glasses, gloves, headwear (for example, a hat, a helmet, a virtual reality headset, an augmented reality headset, a head mounted device (HMD), or a head band), a pendant, an armlet, a leg loop, shoes, or a vest), a gesture recognition apparatus, a microphone, or any electronic apparatus that can provide or render image data.

In an example, after the user inputs the area of interest to the movable platform via the control device, the movable platform may locally store the area of interest, wherein the area of interest may be the planning information of the movable platform. When determining the central area of the local map, the movable platform may obtain the area of interest locally, and may use the area of interest to determine the central area of the local map.

For example, referring to FIG. 4, if the area of interest is an area in front of the movable platform, a certain position (such as position A) in front of position B (that is, the location of the movable platform in the local map) may be determined as the central area of the local map, that is, the central area of the local map is a location of the area of interest.

If the area of interest is an area behind the movable platform, a position behind position B may be determined as the central area of the local map. If the area of interest is an area on a left side of the movable platform, a position on a left side of position B may be determined as the central area of the local map. If the area of interest is an area on a right side of the movable platform, a position on a right side of position B may be determined as the central area of the local map. If the area of interest is an area above the movable platform, a position above position B may be determined as the central area of the local map. If the area of interest is an area below the movable platform, a position below position B may be determined as the central area of the local map.

Certainly, only a few examples of the central area of the local map are described above, and there are no limitation on this matter.

Method 2: obtaining a moving direction of the movable platform, determining a directional relationship between the central area of the local map and the movable platform based on the moving direction, and determining the central area of the local map based on the directional relationship, wherein the directional relationship may include, but is not limited to the moving direction of the movable platform.

In an example, in a moving process of the movable platform, the movable platform may obtain the moving direction of the movable platform, and determine that the directional relationship between the central area of the local map and the movable platform is the moving direction, and then may use the directional relationship to determine the central area of the local map.

For example, as shown in FIG. 4, when the movable platform flies straightly toward a due east direction (that is, the direction from position B to position A), it can be obtained that the moving direction of the movable platform is the due east direction. In other words, the directional relationship between the central area of the local map and the movable platform is the due east direction. Then a position (such as position A) in the due east direction of position B (that is, the location of the movable platform in the local map) is determined as the central area of the local map, that is, the central area of the local map is a position in the due east direction.

When the movable platform flies straightly toward a due west direction, it can be obtained that the moving direction of the movable platform is the due west direction. That is, the directional relationship between the central area of the local map and the movable platform is the due west direction. Then a position in the due west direction of position B is determined as the central area of the local map.

When the movable platform flies straightly toward a due south direction, it can be obtained that the moving direction of the movable platform is the due south direction. That is, the directional relationship between the central area of the local map and the movable platform is the due south direction. Then a position in the due south direction of position B is determined as the central area of the local map.

When the movable platform flies straightly toward a due north direction, it can be obtained that the moving direction of the movable platform is the due north direction. That is, the directional relationship between the central area of the local map and the movable platform is the due north direction. Then a position in the due north direction of position B is determined as the central area of the local map.

When the movable platform flies straightly toward an due upward direction, it can be obtained that the moving direction of the movable platform is the due upward direction. That is, the directional relationship between the central area of the local map and the movable platform is the due upward direction. Then a position in the due upward direction of position B is determined as the central area of the local map.

When the movable platform flies straightly toward a due downward direction, it can be obtained that the moving direction of the movable platform is the due downward direction. That is, the directional relationship between the central area of the local map and the movable platform is the due downward direction. Then a position in the due downward direction of position B is determined as the central area of the local map.

Certainly, only a few examples of the central area of the local map are described above, and there are no limitation on this matter.

Method 3: obtaining a moving direction and a moving speed of the movable platform, determining a directional relationship between the central area of the local map and the movable platform based on the moving direction, determining a distance relationship between the central area of the local map and the movable platform based on the moving speed, and determine the central area of the local map based on the directional relationship and the distance relationship. The directional relationship may include but is not limited to the moving direction of the movable platform. In addition, the distance relationship is proportional to the moving speed of the movable platform.

In an example, in a moving process of the movable platform, the movable platform may obtain the moving direction and the moving speed of the movable platform, and determine that the directional relationship between the central area of the local map and the movable platform is the moving direction. It is determined that the distance relationship between the central area of the local map and the movable platform is proportional to the moving speed, that is, the greater the moving speed, the further the distance between the central area of the local map and the movable platform, and the smaller the moving speed, the closer the distance between the central area of the local map and the movable platform. Then the central area of the local map may be determined by using the directional relationship and the distance relationship.

For example, as shown in FIG. 4, when the movable platform flies straightly toward an due east direction (that is, a direction from position B to position A), it can be obtained that the moving direction of the movable platform is the due east direction. That is, the directional relationship between the central region of the local map and the movable platform is the due east direction. Then a position (such as position A) in the due east direction of position B (that is, the location of the movable platform in the local map) is determined as the central area of the local map, that is, the central area of the local map is a position in the due east direction.

Further, the moving speed of the movable platform may also be obtained. When a position in the due east direction of position B is determined as the central area of the local map, if the moving speed of the movable platform is higher, a distance between the central area of the local map and position B may be father; or if the moving speed of the movable platform is smaller, the distance between the central area of the local map and position B may be closer. A correspondence between the moving speed of the movable platform and the distance may be configured based on experience, and there is no limitation on this matter.

For example, when the moving speed of the movable platform is moving speed 1, the distance between the central area of the local map and position B may be distance 1; when the moving speed of the movable platform is moving speed 2, the distance between the central area of the local map and position B may be distance 2; and so on.

When the movable platform flies straightly toward a due west direction, flies straightly toward a due south direction, flies straightly toward a due north direction, flies straightly toward an due upward direction, or flies straightly toward a due downward direction, for a method of determining the central area of the local map, refer to method 2. The difference is as follows: the distance between the central area of the local map and position B is determined based on the moving speed of the movable platform, that is, the greater the moving speed of the movable platform, the father the distance between the central area of the local map and position B, and the smaller the moving speed of the movable platform, the closer the distance between the central area of the local map and position B. There is no limitation on this matter.

Certainly, only a few examples of the central area of the local map are described above, and there is no limitation on this matter.

Step 303: obtaining map information (that is, map information used for mapping, for example, information about surrounding obstacles, etc.) corresponding to the movable platform. For example, the map information may be obtained via a binocular camera or a TOF camera, and there is no limitation on the map information, as long as the map information can be used to generate a local map.

Step 304: generating a local map based on the map information and the central area of the local map, for example, taking the central area of the local map as a center and generating a local map based on the map information, which is not limited.

In an example, the step of generating a local map based on the map information and the central area of the local map may include but is not limited to: taking the central area of the local map as a center, generating a local map of a predetermined shape (referring to step 301, such as a rectangle), a predetermined size (referring to step 301, such as 16 meters*16 meters*16 meters), and a predetermined direction (referring to step 301, such as the northeast direction) based on the map information. That is taking the central area of the local map as a center, a local map with a size of 16 meters*16 meters*16 meters, a rectangle shape, and a northeast direction, may be generated based on the map information. There is no limitation on the mapping method.

Referring to FIG. 4, assuming that a distance between position A (that is, the central area of the local map) and position B (that is, the location of the movable platform in the local map) is 4 meters, then from a perspective of the central area (that is, position A) of the local map, the central region of the local map is taken as a center, an area of 16 meters*16 meters*16 meters is selected as a local area, and a local map is generated on the basis of the local area.

Further, a final generated local map may include a map within a range of 8 meters in front of the central area (that is, position A) of the local map, a map within a range of 8 meters behind the central area, a map within a range of 8 meters on a left side of the central area, a map within a range of 8 meters on a right side of the central area, a map within a range of 8 meters above the central area, and a map within a range of 8 meters below the central area.

In addition, from a perspective of the location of the movable platform (position B) in the local map, the central area of the local map is taken as a center, and an area of 16 meters*16 meters*16 meters is selected as a local area, and a local map is generated based on the local area. Further, a final generated local map may include a map within a range of 12 meters in front of the movable platform (that is, position B), a map within a range of 4 meters behind the movable platform, a map within a range of 8 meters on the left side of the movable platform, a map within a range of 8 meters on the right side of the movable platform, a map within a range of 8 meters above the movable platform, and a map within a range of 8 meters below the movable platform. Obviously, from a perspective of the movable platform, the area in front of the movable platform is increased by 4 meters without increasing the overall local map.

Step 305: using the local map to perform obstacle detection, and there is no limitation on the obstacle detection method.

Based on the foregoing technical solution, in this embodiment of the present disclosure, the central area of a local map may be determined based on planning information of the movable platform, and the central area of the local map does not overlap with the location of the movable platform in the local map, that is the central area of the local map is outside the location of the movable platform; and the local map is generated based on the map information and the central area of the local map. In this way, in a process of generating the local map, areas of the local map can be set more reasonably. Without increasing the size of the local map, an effective range of the local map can be expanded. Further, without increasing memory consumption and computational complexity, a problem of low map utilization can be resolved. Therefore, map utilization can be improved, and user experience can be improved. Therefore, a highly effective mapping method is provided.

Based on the same inventive idea as the foregoing method, referring to FIG. 5, exemplary embodiments of the present disclosure further provide a movable platform 50, including a memory 501 and a processor 502 (such as one or more processors).

In an example, the memory is configured to store program code; and the processor is configured to invoke the program code, and configured to perform the following operations when the program code is executed:

Determining a designated area of a local map based on planning information of the movable platform, wherein the designated area of the local map does not overlap with a location of the movable platform in the local map, that is, the designated area of the local map is outside the location of the movable platform in the local map; and

Generating a local map based on at least a part of map information obtained by the movable platform and the designated area of the local map.

In an example, when determining the designated area of the local map based on the planning information of the movable platform, the processor is specifically configured to: obtain an area of interest of the movable platform; and determine the designated area of the local map based on the area of interest of the movable platform.

The area of interest is input to the movable platform by a user via a control device.

In an example, when determining the designated area of the local map based on the planning information of the movable platform, the processor is specifically configured to: obtain a moving direction of the movable platform; and determine the designated area of the local map based on the moving direction of the movable platform.

When determining the designated area of the local map based on the moving direction of the movable platform, the processor is specifically configured to: determine a directional relationship between the designated area of the local map and the movable platform based on the moving direction, and determine the designated area of the local map based on the directional relationship.

In an example, when determining the designated area of the local map based on the planning information of the movable platform, the processor is specifically configured to: obtain a moving direction and a moving speed of the movable platform; and determine the designated area of the local map based on the moving direction and the moving speed of the movable platform. When determining the designated area of the local map based on the moving direction and the moving speed of the movable platform, the processor is specifically configured to: determine a directional relationship between the designated area of the local map and the movable platform based on the moving direction; determine a distance relationship between the designated area of the local map and the movable platform based on the moving speed; and determine the designated area of the local map based on the directional relationship and the distance relationship.

In an example, the directional relationship includes the moving direction of the movable platform.

In an example, the distance relationship is proportional to the moving speed of the movable platform.

In an example, when generating the local map based on the at least a part of map information obtained by the movable platform and the designated area of the local map, the processor is specifically configured to:

Taking the designated area of the local map as a center, generate a local map of a predetermined shape and a predetermined size based on the at least a part of map information obtained by the movable platform.

In an example, after generating the local map based on the at least a part of map information obtained by the movable platform and the designated area of the local map, the processor is further configured to: use the local map to perform obstacle detection.

The designated area includes a central area of the local map.

Based on the foregoing technical solution, in this embodiment of the present disclosure, a designated area of a local map may be determined based on planning information of a movable platform, and the designated area of the local map does not overlap with a location of the movable platform in the local map; and a local map is generated based on map information and the designated area of the local map. In this way, in a process of generating the local map, areas of the local map can be set more reasonably. Without increasing a size of the local map, an effective range of the local map can be expanded. Furthermore, without increasing the memory consumption and computational complexity, a problem of low map utilization can be resolved. Therefore, map utilization can be improved, and user experience can be improved. Then a highly effective mapping method is provided.

It can be appreciated that, in the foregoing embodiments, the memory 501 can hold the stored program code even if the power is turned off. One of ordinary skill would understand at the time of filing this disclosure that the memory of the movable platform may include at least one computer-readable non-transitory storage medium (including but not limited to a disk memory, a CD-ROM, an optical memory, and the like). Moreover, the program code may include a set of instructions for generating a map and stored on the at least one storage medium. The processor may include at least one processor in communication with the at least one storage medium. During operation, the at least one processor read and execute the set of instructions to perform the foregoing mapping method.

Based on the same idea as the foregoing method, an embodiment of the present disclosure further provides a computer-readable storage medium comprises a set of computer instructions for generating a map, and when the computer instructions are executed by at least one processor, the set of instructions directs the at least one processor to perform the foregoing mapping method, that is perform following operations:

Determining a designated area of a local map based on planning information of the movable platform, wherein the designated area of the local map is outside a location of the movable platform in the local map; and

Generating the local map based on at least a part of map information obtained by the movable platform and the designated area of the local map.

One of ordinary skill in the art also would understand at the time of filing of this disclosure that the computer-readable storage medium or computer-usable storage medium in the foregoing embodiments of the present disclosure is one form of non-transitory computer-readable storage media that can retrieve stored information even after having been power cycled, for example, ROM, EPROM, EEPROM, hard disk drives, flash memory, optical discs, magnetic tapes, etc.

The system, apparatus, module, or unit described in the foregoing embodiments may be implemented by a computer chip or an entity, or implemented by a product with certain functions. A typical device for implementation is a computer. The specific form of the computer may be a personal computer, a laptop computer, a cellular phone, a camera phone, a smartphone, a personal digital assistant, a media player, a navigation device, an email transceiver, a game console, a tablet computer, a wearable device, or a combination of any of these devices.

For ease of description, when describing the foregoing apparatus, the functions are divided into various units and described separately. Certainly, when the present disclosure is implemented, the functions of each unit may be implemented in one or more software and/or hardware.

One of ordinary skill in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the embodiments of the present disclosure may use a form of a computer program product implemented on one or more computer-usable storage media (including but not limited to a disk memory, a CD-ROM, an optical memory, and the like) that include computer executable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

In addition, these computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or other programmable devices, thereby generating computer-implemented processing. Therefore, the instructions executed on the computer or other programmable devices provide steps for implementing a specific function in one or more processes in the flowcharts and/or in one or more blocks in the block diagrams.

The foregoing descriptions are merely embodiments of the present disclosure but are not intended to limit the present disclosure. For one of ordinary skill in the art, the present disclosure may be subject to various changes and variations. Any modification, equivalent replacement, or improvement made without departing from the concept and principle of the present disclosure should fall within the scope of the claims of the present disclosure.

1. A mapping method for a movable platform, comprising:
determining a designated area of a local map based on planning information of the movable platform, wherein the designated area of the local map is outside a location of the movable platform in the local map; and
generating the local map based on at least a part of map information obtained by the movable platform and the designated area of the local map.

2. The method according to claim 1, wherein the determining of the designated area of the local map based on the planning information of the movable platform further comprises:
obtaining an area of interest of the movable platform; and
determining the designated area of the local map based on the area of interest of the movable platform.

3. The method according to claim 1, wherein the determining of the designated area of the local map based on the planning information of the movable platform further comprises:
obtaining a moving direction of the movable platform; and
determining the designated area of the local map based on the moving direction of the movable platform.

4. The method according to claim 3, wherein the determining of the designated area of the local map based on the moving direction of the movable platform further comprises:
determining a directional relationship between the designated area of the local map and the movable platform based on the moving direction; and
determining the designated area of the local map based on the directional relationship.

5. The method according to claim 1, wherein the determining of the designated area of the local map based on the planning information of the movable platform further comprises:
obtaining a moving direction and a moving speed of the movable platform; and
determining the designated area of the local map based on the moving direction and the moving speed of the movable platform.

6. The method according to claim 5, wherein the determining of the designated area of the local map based on the moving direction and the moving speed of the movable platform further comprises:
determining a directional relationship between the designated area of the local map and the movable platform based on the moving direction;
determining a distance relationship between the designated area of the local map and the movable platform based on the moving speed; and
determining the designated area of the local map based on the directional relationship and the distance relationship.

7. The method according to claim 1, wherein the generating of the local map based on the at least a part of map information obtained by the movable platform and the designated area of the local map comprises:
taking the designated area of the local map as a center, generating the local map of a predetermined shape and a predetermined size based on the at least a part of map information obtained by the movable platform.

8. A movable platform, comprising:
at least one storage medium, including a set of instructions for generating a map; and
at least one processor in communication with the at least one storage medium, wherein during operation, the at least one processor read and execute the set of instructions to:
determine a designated area of a local map based on planning information of the movable platform, wherein the designated area of the local map is outside of a location of the movable platform in the local map; and
generate the local map based on at least a part of map information obtained by the movable platform and the designated area of the local map.

9. The movable platform according to claim 8, wherein when determining the designated area of the local map based on the planning information of the movable platform, the at least one processor performs to:
obtain an area of interest of the movable platform; and
determine the designated area of the local map based on the area of interest of the movable platform.

10. The movable platform according to claim 9, wherein
the area of interest is input to the movable platform by a user via a control device.

11. The movable platform according to claim 8, wherein when determining the designated area of the local map based on the planning information of the movable platform, the at least one processor performs to:
obtain a moving direction of the movable platform; and
determine the designated area of the local map based on the moving direction of the movable platform.

12. The movable platform according to claim 11, wherein when determining the designated area of the local map based on the moving direction of the movable platform, the at least one processor performs to:
determine a directional relationship between the designated area of the local map and the movable platform based on the moving direction; and determine the designated area of the local map based on the directional relationship.

13. The movable platform according to claim 8, wherein when determining the designated area of the local map based on the planning information of the movable platform, the at least one processor performs to:
obtain a moving direction and a moving speed of the movable platform; and
determine the designated area of the local map based on the moving direction and the moving speed of the movable platform.

14. The movable platform according to claim 13, wherein when determining the designated area of the local map based on the moving direction and the moving speed of the movable platform, the at least one processor performs to:
determine a direction relationship between the designated area of the local map and the movable platform based on the moving direction;
determine a distance relationship between the designated area of the local map and the movable platform based on the moving speed; and
determine the designated area of the local map based on the directional relationship and the distance relationship.

15. The movable platform according to claim 12, wherein
the directional relationship comprises the moving direction of the movable platform.

16. The movable platform according to claim 14, wherein
the distance relationship is proportional to the moving speed of the movable platform.

17. The movable platform according to claim 8, wherein
when generating the local map based on the at least a part of map information obtained by the movable platform and the designated area of the local map, the at least one processor performs to:
taking the designated area of the local map as a center, generating the local map of a predetermined shape and a predetermined size based on the at least a part of map information obtained by the movable platform.

18. The movable platform according to claim 8, wherein after generating the local map based on the at least a part of map information obtained by the movable platform and the designated area of the local map, the at least one processor further performs to: use the local map to perform an obstacle detection.

19. The movable platform according to claim 8, wherein
the designated area includes a central area of the local map.

20. A non-transitory computer-readable storage medium, comprising a set of instructions for generating a map, wherein when executed by at least one processor, the set of instructions directs the at least one processor to perform acts of:
determining a designated area of a local map based on planning information of the movable platform, wherein the designated area of the local map is outside a location of the movable platform in the local map; and
generating the local map based on at least a part of map information obtained by the movable platform and the designated area of the local map.
